(19) United States
(12) Patent Application Publication
(10) Pub. No.: US 2009/0275222 A1
(43) Pub. Date: Nov. 5, 2009

(54) Electrical connector with improved board mounting peg

(75) Inventor: Wen-Fang Wang, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/387,292

(22) Filed: Apr. 30, 2009

(30) Foreign Application Priority Data
Apr. 30, 2008 (CN) 200820035896.7

(51) Int. Cl. H01R 12/00

(52) U.S. Cl. 439/82

(57) ABSTRACT

An electrical connector (100) is adapted for mounting to a circuit substrate having a board-mounting face (12) and a mounting peg (13) projecting from said board-mounting face (12). Said mounting peg (13) is bifurcated and defines a pair of legs (136,137) separated by an axial slit (132). Protrusions 134 are formed on the inner wall of both legs (136,137) to limit the deflection so as to prevent said legs (136,137) from breakage.

### BACKGROUND OF THE INVENTION

1. Field of the Invention

The present invention generally relates to an electrical connector, and more particularly, to an novel structure of a mounting peg or post for securing an electrical connector to a printed circuit board through a hole in the board.

2. Description of Related Art

It is known to provide electrical connectors with means for securing the connector to a printed circuit board. Often, the connector has a molded thermoplastic housing and boardlock means is formed integral therewith. A typical form of boardlock is a snap latch for securing a connector block or housing to the printed circuit board. The snap latch typically is a molded plastic peg which is bifurcated to define a pair of resilient legs having latching barbs or hooks thereon. The legs, during insertion through a hole in the printed circuit board from a first side of the board, deflect inwardly toward the axis of the snap latch. As the hooks on the ends of the legs pass through the hole in the board, the legs bounce back outwardly into a position with shoulders on the hooks extending beyond the periphery of the hole and engaging a second side of the board, thereby securing the connector to the board. The pegs usually are an integral part of the connector housing or, in some instances, separate metal snap latches have been used.

U.S. Pat. No. 5,378,172 issued to Roberts on Jan. 3, 1995 just discloses such kind of snap latch boardlock. As the legs pass through the hole in the board, the legs snap back outwardly into a position with shoulders on the hooks extending beyond the periphery of the hole and engaging a second side of the board, thereby securing the connector to the board. However, the legs will encounter a deformation while passing through the hole in the board, after bending over some extent in the space between two legs, the problem of breakage is particularly prevalent with the brittle plastic material which presently is used quite often in molding connector housings.

Hence, the present invention is directed to solving this problem in a typical bifurcated mounting peg by limiting the deflection required to install or uninstall the peg into the hole in the circuit board.

### SUMMARY OF THE INVENTION

An object, therefore, of the invention is to provide a new and improved electrical connector of the character described above, with a novel mounting peg structure.

In order to achieve the object set forth, an electrical connector is adapted for mounting to a circuit substrate having a board-mounting face and a mounting peg projecting from said board-mounting face. Said mounting peg is bifurcated and defines a pair of legs separated by an axial slit. Protrusions are formed on the inner wall of both legs to limit the deflection so as to prevent said legs from breakage.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of the electrical connector of an embodiment of the present invention;

FIG. 2 is an exploded, perspective view of the electrical connector as shown in FIG. 1;

FIG. 3 is another perspective view of the electrical connector as shown in FIG. 1; and

FIG. 4 is an enlarged, perspective view of the mounting peg as shown in FIG. 3.

### DETAILED DESCRIPTION OF THE INVENTION

Reference will now be made in detail to the preferred embodiment of the present invention.

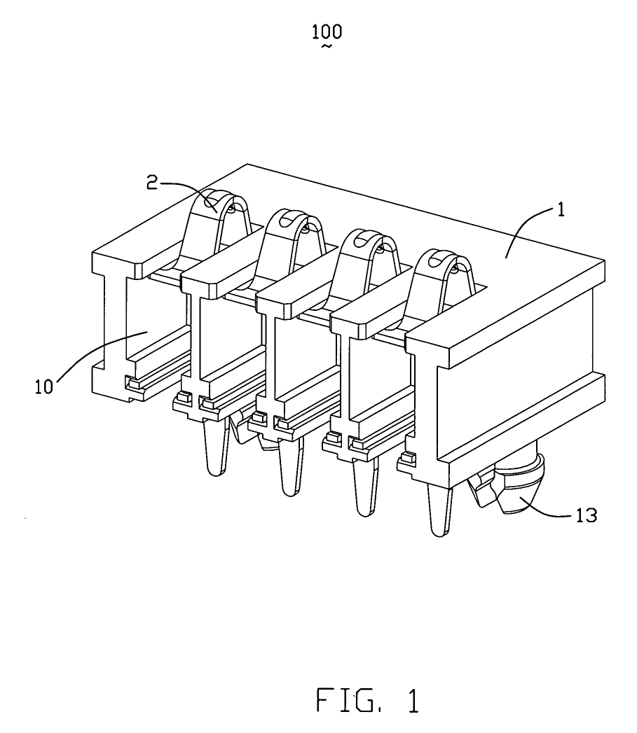

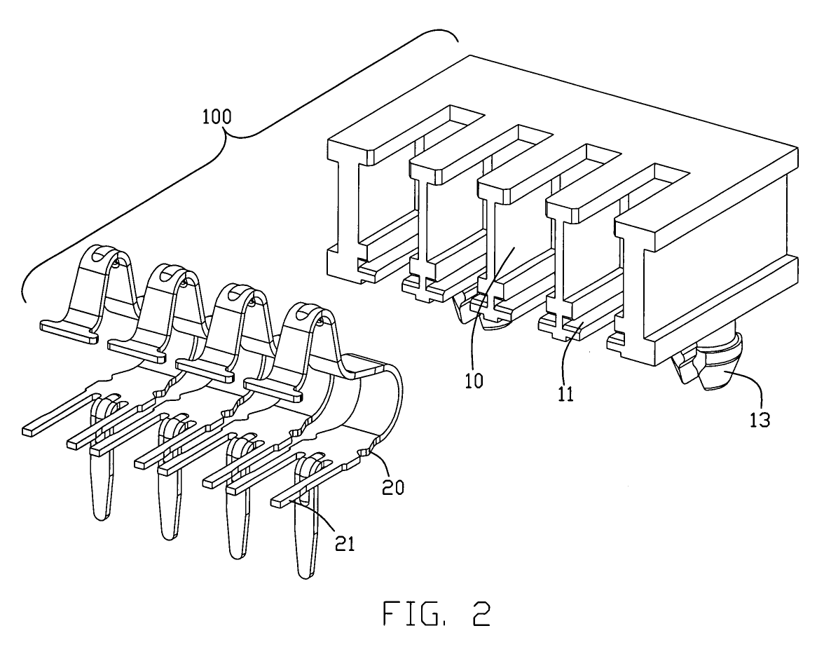

Referring to FIGS. 1-2, an electrical connector 100 for mounting on a circuit substrate (not shown) in accordance with the embodiment of the present invention comprises a dielectric housing 1 with a number of parallel terminal passages (10,11) extending to an exterior in both vertical and horizontal directions, and a plurality of terminals 2 with fixing portion (20,21) received in said terminal passages (10,11) and deflectably moving within the terminal passages (10,11) with corresponding contact sections (not labeled) extending out of a front face of the housing 1.

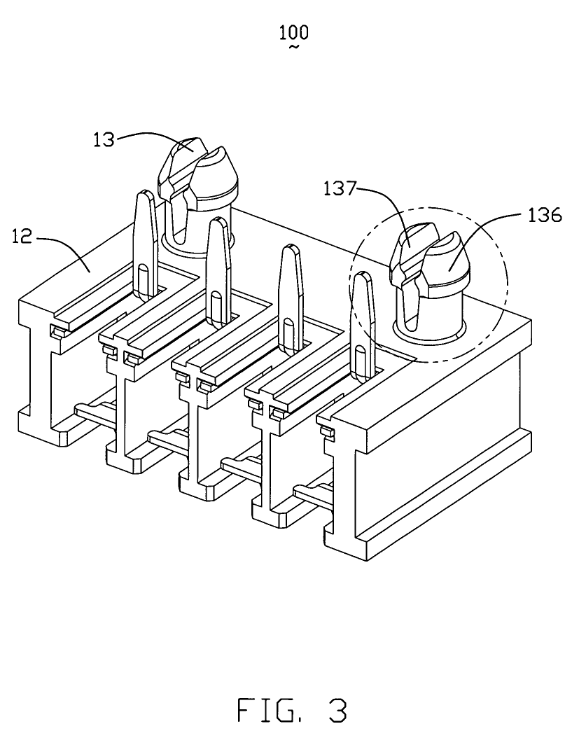

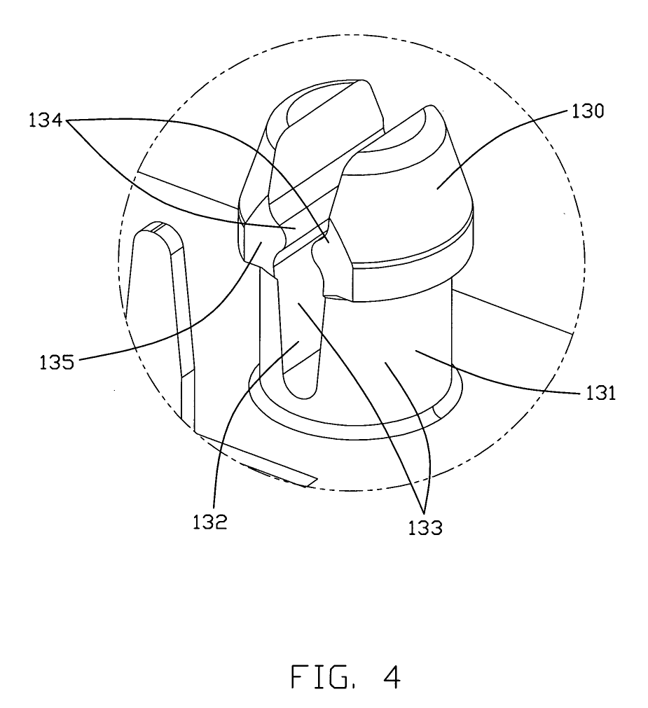

Referring to FIGS. 3-4, the dielectric housing 1 further comprises a board-mounting face 12 and two mounting pegs 13 projected from said board-mounting face 12. Each of said mounting pegs 13 is bifurcated and defines a pair of legs (136,137) separated by an axial slit 132, which makes the legs (136,137) flexible under deformation.

Referring to FIG. 4, each mounting peg 13 comprises a cylindrical portion 131 and a cone-shaped mounting portion 130 united by the free end of said legs (136,137). Said cone-shaped mounting portion 130 has a maximum diameter, which makes the joint of the cylindrical portion 131 and the cone-shaped mounting portion 130 forms a latching barb (not labeled) to extend beyond the periphery of the hole (not shown) and secure the connector 100 to the second side of the board (not shown).

Still referring to FIG. 4, said axial slit 132 is essentially coincident with the central axis of the mounting peg 13 and is formed in a V-shaped configuration and is symmetrical to the central axis of the mounting peg 13 so as to make better flexibility of both legs (136,137). Protrusions 134 as a continuous rib parallel to said terminal passages 10 are formed on the axial slit 132 respectively to the maximum diameter of the mounting peg 13. When the pegs 13 are pushed through the holes of the printed circuit board to mount the connector thereon, the inner surface of the legs (136,137) will abut against each other so as to prevent the legs (136,137) from over-stretching thereby advantageously avoiding the breakage of the legs (136,137).

It should be noted that, in this embodiment, the axial slit 132 is essentially coincident with the central axis (not labeled) of the mounting peg 13 and the protrusions 134 are set on both legs (136,137). In some other embodiments, axial slit 132 can also be deflected from the central axis of the mounting peg 13 and either of the legs (136,137) has protrusion 134 will remain available.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
a dielectric housing having a plurality of passageways extending to an exterior in both vertical and horizontal directions, the housing having a board-mounting face;
a plurality of contacts disposed in the housing and deflectably moved within the passageways with corresponding contact sections extending out of a front face of the housing;
at least one mounting peg projecting from the board-mounting face and having a portion, with a maximum diameter, away from an end of the mounting peg, said mounting peg being bifurcated into a pair of legs with an axial slit therebetween; and
said portion of the mounting peg having a pair of protrusions respectively on an inner faces of said legs and laterally into said axial slit.

2. The electrical connector as claimed in claim 1, wherein each of said protrusions is a continuous strip parallel to said passageways.

3. The electrical connector as claimed in claim 2, wherein said axial slit is essentially coincident with the central axis of the mounting peg.

4. The electrical connector as claimed in claim 3, wherein said axial slit is formed in a V shape.

5. The electrical connector as claimed in claim 4, wherein the opening angle of the V-shaped axial slit is symmetrical to the central axis of the mounting peg.

6. An electrical connector, comprising:
a dielectric housing having terminals mounted therein and including a board-mounting face;
at least one mounting peg being bifurcated into a number of legs, said mounting peg including a cylindrical base and a cone-shaped header, the header having a maximum diameter of the mounting peg; and
a central hollow is formed in axial direction of the mounting peg and at least one protrusion projecting in said central hollow.

7. The electrical connector as claimed in claim 6, wherein said protrusion is formed on the inner hollow respectively to the maximum diameter.

8. The electrical connector as claimed in claim 7, wherein at least one of the legs has protrusion formed thereon.

9. The electrical connector as claimed in claim 8, wherein said mounting peg is bifurcated into a pair of legs separated by the central hollow.

10. The electrical connector as claimed in claim 9, wherein each of said protrusions is a continuous strip parallel to said passageways.

11. The electrical connector as claimed in claim 10, wherein said central hollow is formed in a V shape.

12. An electrical connector assembly comprising:
an insulative housing defining a mounting face;
a mounting peg unitarily downwardly extending from the mounting face, said mounting peg including an upper portion and a bottom portion with an enlarged cone like head around a bottom portion thereof and an upside-down V-like slot extending through both said upper portion and said bottom portion to bifurcate the mounting peg into a pair of legs with a pair of interior surfaces facing to each other; and
a pair of ribs formed on said interior surfaces, respectively, and located around a level where said peg defines a maximum diameter thereof.
